(19) United States
(12) Patent Application Publication
(10) Pub. No.: US 2010/0198774 A1
(43) Pub. Date: Aug. 5, 2010

(54) Systems and Methods for Aligning Multiple Point Sets

(75) Inventor: Daniel P. Fasulo, Titusville, NJ (US)

Correspondence Address: LIFE TECHNOLOGIES CORPORATION;C/O INTELLEVATE, P.O. BOX 52050, MINNEAPOLIS, MN, 55402, US

(73) Assignee: LIFE TECHNOLOGIES CORPORATION, Carlsbad, CA (US)

(21) Appl. No.: 12/548,404

(22) Filed: Aug. 26, 2009

Related U.S. Application Data
(63) Continuation of application No. 11/047,957, filed on Jan. 31, 2005, now abandoned.
(60) Provisional application No. 60/540,817, filed on Jan. 30, 2004.

(51) Int. Cl. G06N 5/02

(52) U.S. Cl. 706/54

(57) ABSTRACT

Many biological data analysis problems require matching data points from different data sets. For example, high-throughput protein expression liquid chromatography and mass spectrometry (LC/MS) protocols developed generate 2-dimensional feature sets that require matching on a point-by-point basis. In these protocols, it can be useful to perform all data collection sequentially and analyze the data subsequent to lab work. This avoids the need to identify all of the components in a sample before comparing it to other samples, thus saving effort and avoiding the potential problem of missing an important component due to problems in the identification stage. Such methods can involve identifying, grouping and measuring sets of characteristic peaks in order to identify and quantify shared peptides. The present teachings provide, among other things, a method for comparing and associating multiple data sets. These methods, can be used, for example, for analyzing LC/MS runs, gel images etc.

### CROSS-REFERENCE TO RELATED APPLICATIONS

This application is a continuation of U.S. patent application Ser. No. 11/047,957 filed Jan. 31, 2005 and claims a priority benefit under 35 U.S.C. §119(e) from U.S. Patent Application No. 60/540,817, filed Jan. 30, 2004, which is incorporated herein by reference.

### FIELD

The present teachings pertain to systems and methods of aligning and analyzing point sets.

### BRIEF DESCRIPTION OF THE DRAWINGS

The skilled artisan will understand that the drawings, described below, are for illustration purposes only. The drawings are not intended to limit the scope of the present teachings in any way.

FIG. 1 Raw LC/MS data. Horizontal slices represent MS spectra of samples taken from an LC column at different times.

FIG. 2 Zoomed view of LC/MS data where spots have been reduced to mass/charge, retention time and intensity data triples.

FIG. 3 Example of rectangle overlap and data points belonging to two cliques. Rectangles are centered on peaks and have dimensions determined by measurement error.

FIG. 4 Example of one-dimensional sweepline technique useful for determining clique membership. A sweepline travels in the x-dimension and emits cliques {a,b}, {c,d,e} and {e,f}.

FIG. 5 Example of two-dimensional sweepline technique useful for determining cliques.

FIG. 6 Centroid test for determination of sub-cliques. Areas induced in cliques C′ and C″ contain the centroid of C and therefore are sub-cliques.

FIG. 7 Resolving ambiguous rectangles. R more properly belongs to clique {R4, R5} since the average overlap is greater than with rectangles in {R1, R2, R3}.

FIG. 8 Accuracy and speed comparison against pair-wise combination method.

FIG. 9 Computer systems for implementing data alignment method.

### INTRODUCTION

Protein expression studies can be invaluable in understanding basic biology and disease. Information gained from protein expression compares favorably to that obtained from mRNA expression. However, the technology behind protein expression analysis is less mature than that used for mRNA analysis, and many technical difficulties exist.

Recently developed liquid chromatography and mass spectrometry (LC/MS) protocols permit the study of high-throughput protein expression. In such protocols, protein mixtures are often digested into peptides and run through one or more chromatography stages. The output from the final chromatographic column can be sampled regularly, typically over a period of one to four hours, and the samples analyzed by a mass spectrometer. Each peptide produces a characteristic signal in the spectrometer, and these signals can be identified and gathered into features with a representative mass/charge (m/z) ratio, column retention time (rt), and signal intensity. A well-designed experiment will generally result in each peptide possessing a unique m/z, rt) pair.

Early LC/MS protocols attempted to identify each peptide as it appeared in a mass spectrometer via tandem mass spectrometry (MS/MS). In many applications it can be more efficient to run many samples, identify peaks corresponding to peptides of interest, and later determine their identities. This requires the ability to compare the output of multiple LC/MS experiments, often called LC/MS maps, and identify which features correspond to the same peptide using only the (m/z, rt) pair information. This process is similar to comparing and associating spots on different two-dimensional gel images and is often referred to as the feature identification procedure. Once this procedure is complete, the data can be transformed into a matrix format where, for example, the rows correspond to peptides, columns correspond to experiments and matrix entries are the peptide intensities. Accuracy in peptide feature identification is often important to the quality of further analysis.

Two-dimensional gel electrophoresis (2DE) is another technology for conducting protein expression studies. For a comparison of 2DE and LC/MS see the following reference. (S. P. Gygi, G. L. Corthals, Y. Zhang, Y. Rochon, and R. Aebersold. Evaluation of the two-dimensional gel electrophoresis-based proteome analysis technology. Proceedings of the National Academy of Sciences, 97(17):9390-9395, 2000.) Despite differences in experimental technique, the problem of comparing results is similar to the LC/MS case. In 2DE, proteins form a set of spots on a gel. Software can be used to identify and quantify the spots, giving each spot a characteristic mass, isoelectric point, and intensity. These are analogous to the m/z, rt, and intensity values found in LC/MS maps. Typical software packages perform pair-wise analysis of gel images by comparing a new gel to a reference or a set of database gels. Pair-wise feature map comparison can be extended to a multi-feature map comparison by wrapping the pair-wise comparison into a hierarchical method like single-link clustering. (R. Sibson. SLINK: an optimally efficent algorithm for a complete link method. The Computer Journal, 16:30-34, 1973.) However, greedy hierarchical methods often perform poorly in the presence of significant noise. This is often due to an inherent difficulty in avoiding incorrect matchings at the pair-wise level.

While pair-wise comparison methods could be applied to LC/MS data, the present teachings provide several advantages over such methods. For example, the present teachings do not require a reference map. As well, the present teachings work well in noisy environments. LC/MS has the potential to be a high-throughput approach and a typical large-scale LC/MS experiment might involve running dozens of healthy samples, each with several replicates, and as many diseased samples, each with several replicates. The replicates can be important because LC/MS spectra are typically noisy and a large percentage of false features often appear in each map—potentially more false features than real ones. This can occur particularly when preprocessing software is tuned to be sensitive to low-abundance peptides. From this information, the researcher wishes to identify which features occur in which samples, and in particular, which are differentially expressed between the healthy and diseased classes.

### DESCRIPTION

The present teachings are useful for analyzing many LC/MS maps simultaneously, with or without a reference, and in the presence of significant amounts of noise.

Some embodiments of the present teachings associate with each feature a rectangular area of uncertainty. These rectangles can be selected so that features are more likely to be identical if their rectangles overlap. The rectangles can be constructed with prior knowledge of the measurement error, which can be obtained via simple experiments or estimated. The rectangles from all of the LC/MS maps are overlaid, and sets of mutually intersecting rectangles are identified. These represent the sets of features that originate from the same peptide; however, rectangles may appear in multiple sets. A heuristic can be used to assign each rectangle to the correct set. Since the heuristic has simultaneous access to all of the sets and their contents, the potential for more accurate results as compared to a greedy pair-wise merging strategy exists.

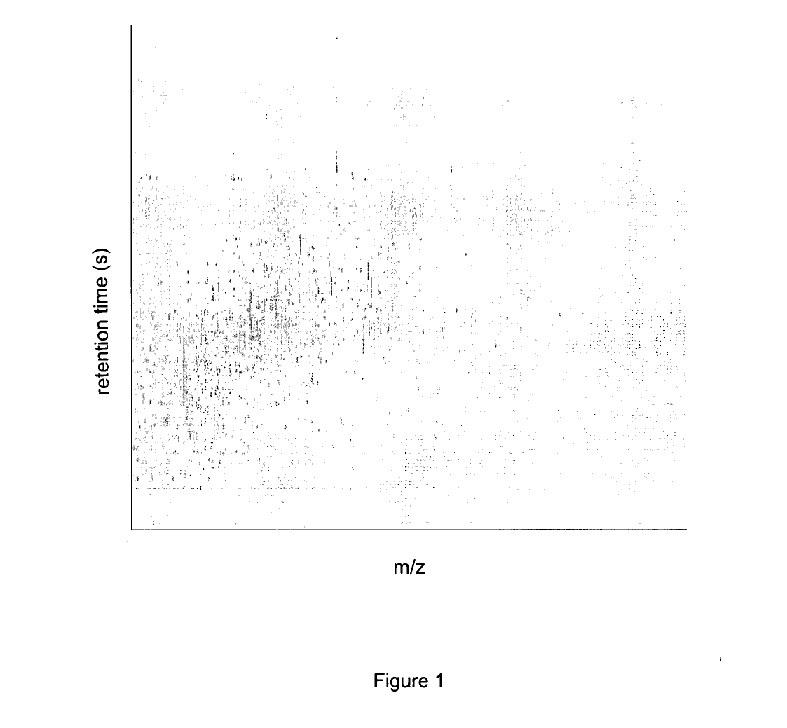

Prior to comparison, LC/MS maps are acquired and processed. Processing, is generally handled by signal processing software associated with the instrument. The present teachings can be used with a variety of LC/MS machines such as, but not limited to, the LCQ LC-MS from ThermoFinnigan, 1100 Series Trap/SL LC-MS from Agilent, MicroQuattro LC-MS from Waters or the API 2000™ LC/MS/MS System from Applied Biosystems. The instrument identifies features and provides the mass/charge ratio, elution time, intensity, and charge state of each feature. Generally, the features of interest are mass/charge ratio and elution time. In general, the accuracy of mass/charge ratios is higher than elution time, which can have significant variability. FIG. 1 shows LC/MS raw data. The x-axis represents the mass to charge ratio and the y-axis represents the retention time. The spots are peaks. The darker the spot, the greater its intensity. One skilled in the art will appreciate that they are many different methods of extracting the mass/charge, retention time, intensity data triples from such a map. Commercial software such as GPS Explorer (Applied Biosystems), Bioanalyst (Sciex), and the Razor Library (Spectrum Square Associates Inc.) is available to perform such functions

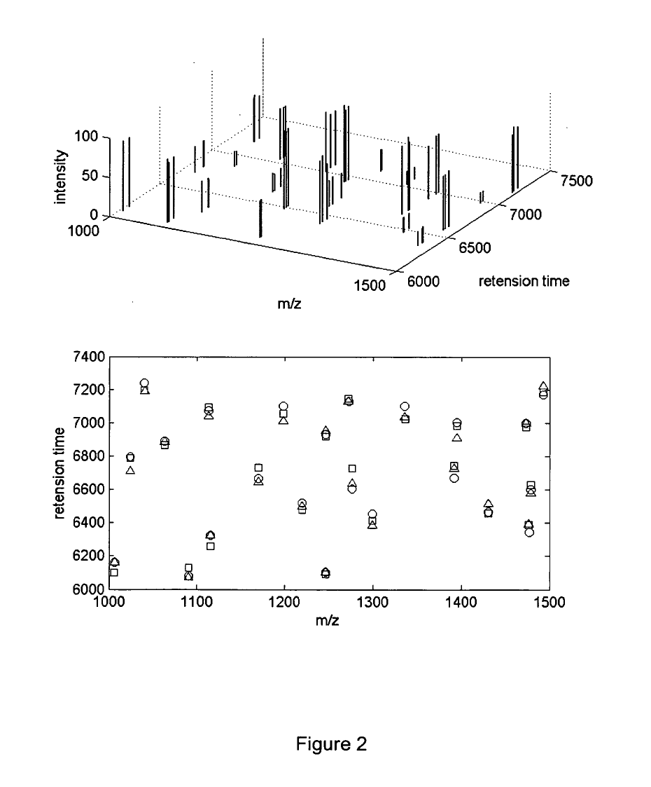

FIG. 2 illustrates a portion of three LC/MS maps overlaid. Here, the problem of data alignment becomes evident. In FIG. 2a, the three maps do not align exactly and clusters of 3 peaks are identifiable. Due to experimental noise and measurement error the clusters do not always share the same geometric distribution and thus a simple translation generally cannot be used to align the points. As well, as the map becomes denser, the difficulty of alignment increases. FIG. 2b shows an overhead view of the data in FIG. 2a. Three different icons are used to represent the contributions from the three different data sets. Because the m/z data generally varies less than the retention time, features appear more regular in that dimension. The appearance of such colinearity is not required for the present method to work and in fact this alignment would not be as readily apparent as the data density increases.

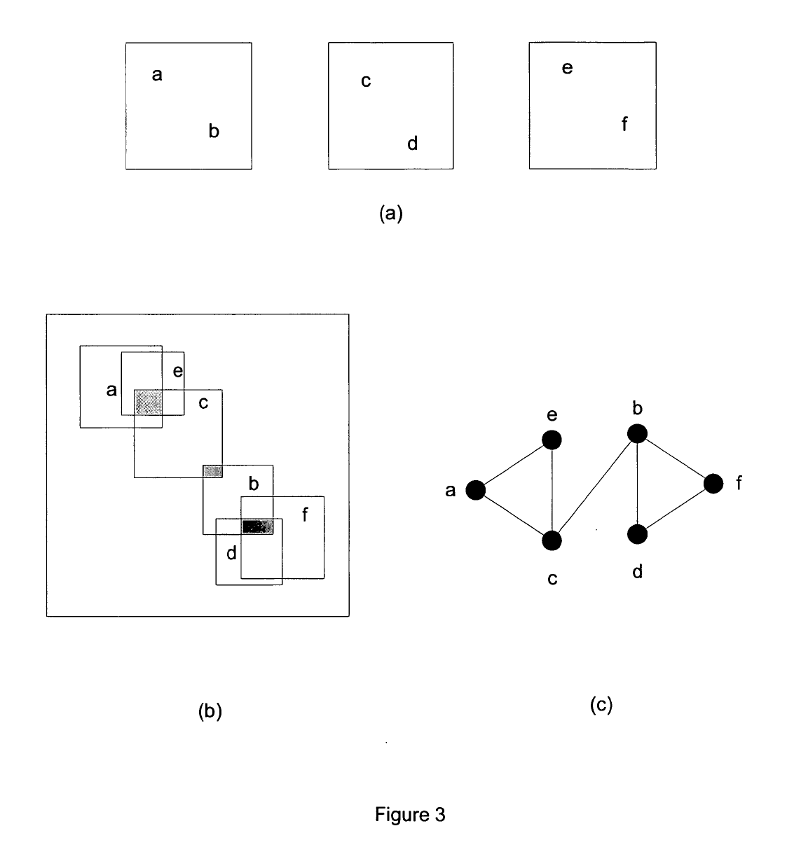

In some embodiments, the input is a set of points (x₁, y₁), (x₂, y₂), . . . , (x_{N},y_{N}) where the x-dimension represents the mass/charge measurements, and the y-dimension the elution time. The points correspond to the set of features identified across all maps. For each feature (xᵢ, yⱼ), εₓ(xᵢ)=(xᵢ^{l}, xᵢ^{u}) represents the uncertainty interval surrounding xᵢ with lower bound xᵢ^{l} and upper bound xᵢ^{u}. For example, if xᵢ is the observed mass/charge ratio of a peptide in an LC/MS experiment, then the actual mass/charge ratio of the peptide lies within the interval (xᵢ^{l}, xᵢ^{u}). Likewise, ε_{y}(yᵢ) can represent the uncertainty interval around yᵢ and the set (εₓ(xᵢ), ε_{y}(yᵢ)) represents a rectangular region, Rᵢ, the plane. The set of rectangles derived from the input points can be represented by R={R₁, R₂, . . . , R_{N}}. Two features in the input set can be said to be compatible if their corresponding rectangles intersect. This indicates that both features might be observations of the same peptide. One stage of the feature identification procedure is to identify maximal sets (cliques) of mutually compatible features. FIG. 3, shows a simple example where there are three input experiments, each with two features represented by letters as shown in FIG. 3a. The features are combined into a single data set and rectangles generated for each, as shown in FIG. 3b. The corresponding rectangle overlap graph is shown in FIG. 3c which results in definition of the maximal cliques {a,c,e}, {c,b}, and {b,d,f}. The first step of the procedure identifies cliques whose areas of mutual intersection are highlighted in FIG. 3b. Note that b and c each appear in two cliques. Some embodiments address this issue, by assigning b and c to the larger cliques so that the final result would have two cliques, {a,c,e} and {b,d,f}.

Some embodiments construct rectangular overlap graphs. In such embodiments, R can represent a set of iso-oriented rectangles in the plane, and G can represent an undirected graph such that there is a vertex corresponding to each rectangle in R and an edge between every pair of overlapping rectangles. Such a graph is called a rectangle overlap graph and is illustrated in FIG. 3c. Rim and Nakajima have written a survey of results on rectangle overlap graphs. (C. Rim and K. Nakajima. Complexity results for rectangle intersection and overlap graphs. Technical Report TR 88-64, The Institute for Systems Research, University of Maryland, 1988.) One skilled in the art will appreciate that there are several ways of finding all maximal cliques in a rectangle overlap graph. For example, Gentleman and Vandal, discuss graph-theoretic approaches such as explicitly constructing the graph from the input rectangles and taking advantage of the graph's structure to achieve an O(n^{s}) method, where n is the number of rectangles. (R. Gentleman and A. C. Vandal. Computational algorithms for censored data problems using intersection graphs. Journal of Computational and Graphical Statistics, to appear.) Some embodiments use a more efficient approach based on computational geometry. Computational geometry approaches have been used to solve the problem of finding the size of the maximum clique in a rectangle overlap graph in O(n log n) time; however, these approaches rely on a special segment tree structure which does not generalize to the problem of finding all cliques. (P. Bose, M. van Kreveld, A. Maheshwari, P. Morin, and J. Morrison. Translating a regular grid over a point set. Computational Geometry: Theory and Applications, 2001.) Still other embodiments use a computational geometry implementation approach that leads to an O(n³+n²k) worst-case running time, where k is the number of cliques. The actual running time is generally lower for real data since the worst case is only approached when most pairs of rectangles intersect.

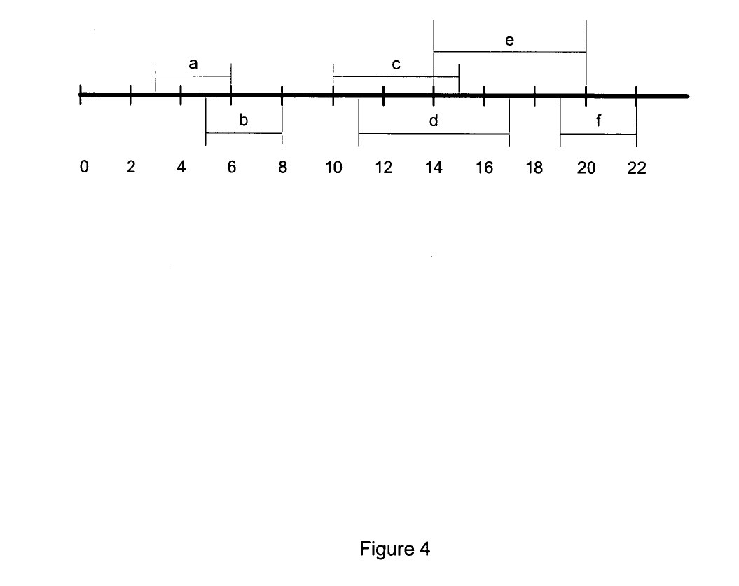

To implement such a method some embodiments employ an extension of the sweepline approach for finding maximal cliques among a set of intervals on a line. In the sweepline approach, the interval end points are the events, which the sweepline must process. In the sweepline method, a priority queue can be used to keep track of events to be processed by the sweepline. The queue tracks all of the intervals crossing the sweepline, and sorts them by their termination point. First, the left-hand end points of the intervals are sorted and the sweepline is placed at the leftmost point. At each step, the next event to be processed is either the next point from the list of left-hand end points (called a BEGIN event) or the next interval termination point from the sweepline (called an END event), depending on which is closer. In the event of a tie, the BEGIN event is generally processed first. When a BEGIN event is processed, the corresponding interval is placed into the sweepline. The sweepline must also be marked LIVE. This marking scheme is used to avoid emitting sub-cliques of a previously-emitted clique; it is easy to see that a super-clique will never be emitted because cliques are emitted only when an interval is ending. When an END event is processed, if the sweepline is marked LIVE then all intervals on the sweepline are output as a clique. The sweepline is then marked DEAD. If the sweepline was already marked DEAD, then no output occurs. Also, the interval that ended at the event is removed from the sweepline. As an example, see FIG. 4. On the one-dimensional line, six intervals occur (a, b, c, d, e, and f). At timepoint 4, the sweepline has already been marked LIVE since a BEGIN event occurred at timepoint 3. At timepoint 6, the sweepline is marked DEAD since an END event is processed and clique comprising events a and b is emitted. At timepoint 12, the sweepline is LIVE and at timepoint 15 the sweepline is DEAD since the and END event from interval c has been processed. A second clique comprising c, d, and e is emitted. At timepoint 19 the sweepline is marked LIVE again and at timepoint 20 it is marked DEAD and a clique comprising intervals e and f is emitted.

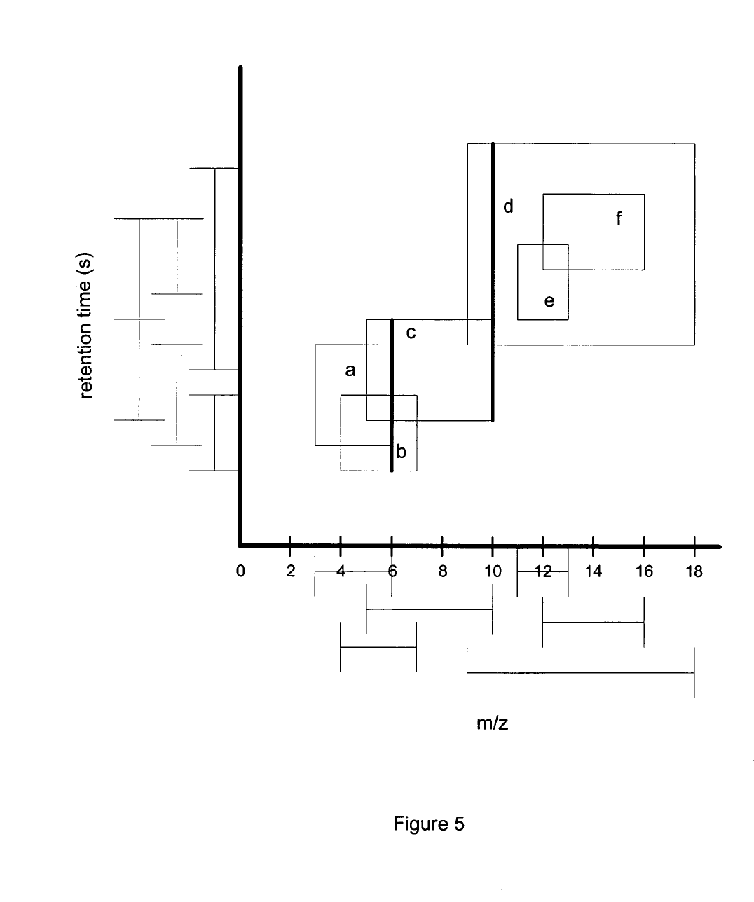

The two-dimensional case is very similar. FIG. 5 shows an example. Here a sweepline moves down the x-axis until an end event occurs. Then the 1-dimensional sweepline approach is used along the y-axis to output the cliques. Only the rectangles intersecting the rectangle owning the end event are emitted as a clique. If two rectangles end at the same x point, their y-axis sweeplines are processed separately. In FIG. 5, end events at m/z 6 and 10 cause emission of cliques {a, b, c} and {c, d} respectively.

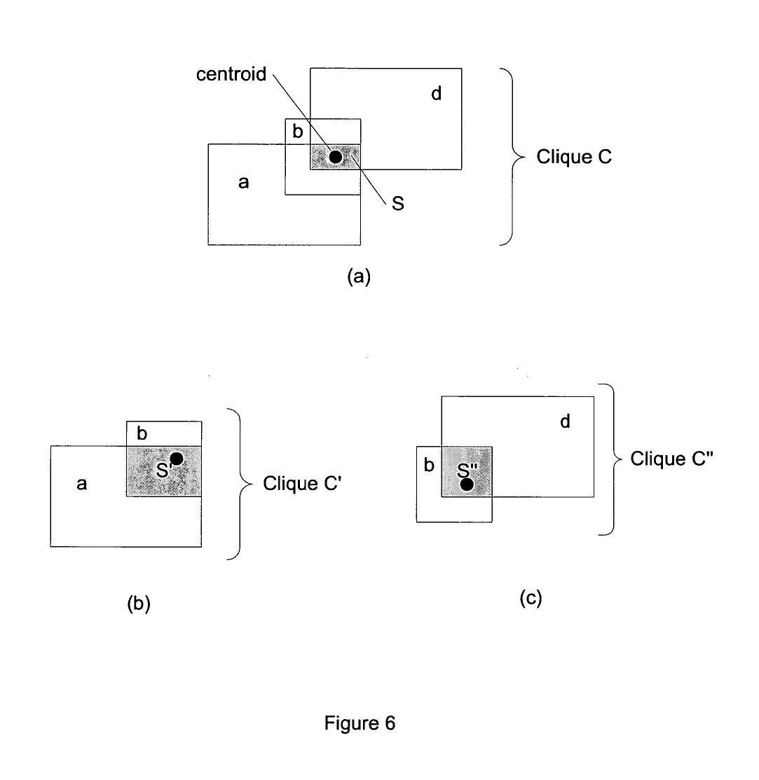

Emission of sub-cliques of previously emitted cliques can be prevented via a simple observation. In FIG. 6a S is the rectangular region of intersection induced by a maximal clique C composed of {a, b, d} in the rectangle overlap graph: its centroid is marked. In FIG. 6b a clique C′ whose rectangular region of intersection is S′ has also been emitted by the sweepline approach. The sub-clique can be removed from further consideration by performing a centroid test. If S′ contains the centroid, C′ is a sub-clique of C. The cliques in FIGS. 3b and 3c are both sub-cliques because their induced regions S′ and S″ both contain the centroid as illustrated.

In some embodiments, the rectangles are projected to the x-axis, yielding a set of intervals. A sweepline processes these intervals as described above. However, the sweepline structure is itself a set of intervals in the y-dimension. When a left endpoint is encountered in the x-axis, the interval of the associated rectangle in the y-dimension is placed into the sweepline. When a right endpoint is encountered for the rectangle R, then the one-dimensional algorithm is run upon the intervals in the sweepline, and those cliques containing R are considered. Each clique is compared against the list of previously-emitted centroids as described above. If no centroids are contained within the clique's area of intersection, the clique is output and its centroid is added to the set of centroids.

A practical consideration is the assignment of rectangles to multiple cliques. If the input maps are sufficiently dense, this can be problematic. As each clique ideally represents a distinct peptide, resolving the assignment of ambiguous rectangles to cliques is important for the final result. Some embodiments assign rectangles to cliques using global context information thus performing a global optimization. Some embodiments employ randomized assignment, models of clique size distributions, models of intensity and charge distributions, or models of noise distribution. One skilled in the art will appreciate that a variety of assignment methodologies can be fashioned. Some embodiments employ a heuristic patterned on the expectation-maximization algorithm. For example, if area(R₁,R₂) denotes the area of intersection between rectangles R₁ and R₂, a score, s(R,C), for rectangle R with respect to clique C can be computed as follows.

$$s ( R , C ) = \{ \begin{matrix}0 & if C - \{ R \} = ∅ , or \\ \frac{{\sum }_{{R}^{′} ∈ C - \{ R \}} area ( R , {R}^{′} )}{\vert C - \{ R \} \vert} & otherwise\end{matrix}$$

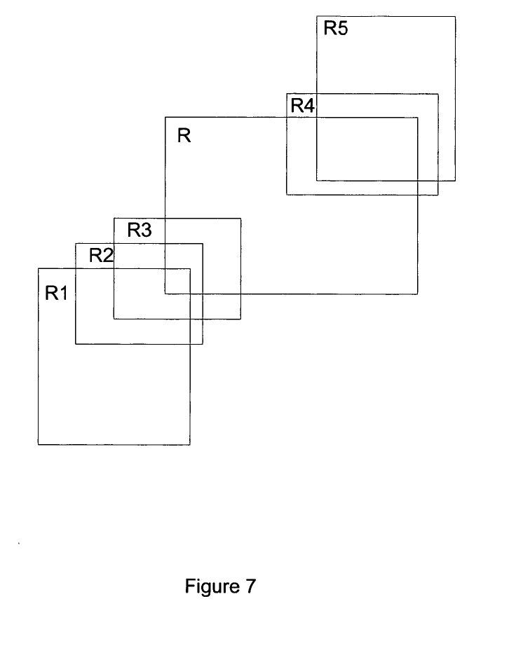

The rectangle is then assigned to the clique that yields the greatest score. This scoring scheme generally avoids assigning rectangles to singleton cliques, and otherwise assigns them to cliques with which the average fit is best. Initially, each ambiguous rectangle is assigned to a clique. Some embodiments assign it to the clique with the most members. Then, the assignment procedure is iterated. During each iteration, each ambiguous rectangle R is moved to the clique C that maximizes s(R,C). Iteration can be terminated when there is no change or a maximum number of iterations is reached. Implementation of the scoring mechanism is illustrated in FIG. 7. Here ambiguous rectangle R is initially assigned to the clique comprising R1, R2 and R3. On the next iteration, R is assigned to the clique comprising R4 and R5 because the average overlap with each member of that clique is greatest. Some embodiments employ additional heuristics such as expanding the s function to include terms for how well various other properties of the feature associated with fits in with the features in C such as charge state, intensity, etc.

### Computer Implemented System

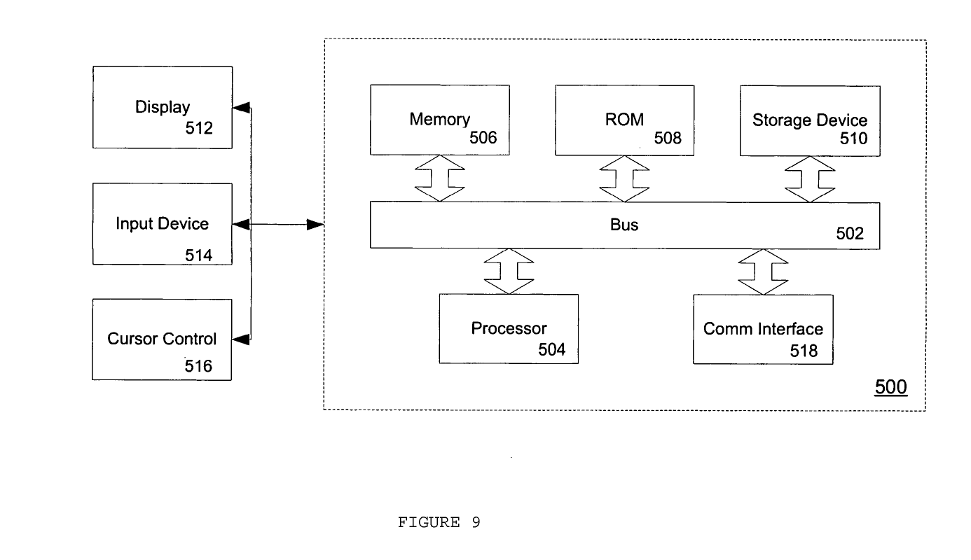

FIG. 9 is a block diagram that illustrates a computer system 500, upon which embodiments of the invention may be implemented. Computer system 500 includes a bus 502 or other communication mechanism for communicating information, and a processor 504 coupled with bus 502 for processing information. Computer system 500 also includes a memory 506, which can be a random access memory (RAM) or other dynamic storage device, coupled to bus 502 for determining base calls, and instructions to be executed by processor 504. Memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT) or liquid crystal display (LCD), for displaying information to a computer user. An input device 514, including alphanumeric and other keys, is coupled to bus 502 for communicating information and command selections to processor 504. Another type of user input device is cursor control 516, such as a mouse, a trackball or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

A computer system 500 performs the alignment method. Consistent with certain implementations of the invention, matched data points are provided by computer system 500 in response to processor 504 executing one or more sequences of one or more instructions contained in memory 506. Such instructions may be read into memory 506 from another computer-readable medium, such as storage device 510. Execution of the sequences of instructions contained in memory 506 causes processor 504 to perform the process described herein. Alternatively hard-wired circuitry may be used in place of or in combination with software instructions to implement the invention. Thus implementations of the invention are not limited to any specific combination of hardware circuitry and software.

The term “computer-readable medium” as used herein refers to any media that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as memory 506. Transmission media includes coaxial cables, copper wire, and fiber optics, including the wires that comprise bus 502. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on the magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector coupled to bus 502 can receive the data carried in the infra-red signal and place the data on bus 502. Bus 502 carries the data to memory 506, from which processor 504 retrieves and executes the instructions. The instructions received by memory 506 may optionally be stored on storage device 510 either before or after execution by processor 504.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. Additionally, the described implementation includes software but the present invention may be implemented as a combination of hardware and software or in hardware alone. The invention may be implemented with both object-oriented and non-object-oriented programming systems.

### EXAMPLES

Some of the embodiments herein are implemented in a software package called Rectangle Aggregator (RAG). RAG's performance has been compared to a program called the Aggregator that was developed to solve the feature identification problem using a hierarchical merging method. Results from RAG and the Aggregator on both simulated and real data are presented.

### Example 1

### Simulated Data

Simulated data has the advantage of being controllable and results from it are often more easily evaluated than when using real data. To test RAG, a large number of data sets were created. For each data set, a reference map was created with a number of features. The reference map was used only to assess the results. Each input map was populated with one observation per reference feature, normally distributed around the reference feature's position in both dimensions (m/z, rt). A number of uniformly distributed noise points were added to each map. The number of true features, noise features, and maps were varied to create many data scenarios. Ten replicates were performed for maps with 500 reference features; five were performed for maps with 2000 reference features. In each replicate, the input maps were provided to RAG and the Aggregator; neither program made use of the reference map. Each program was given a maximum matching distance in the mass/charge and retention time dimensions based on the parameters of the simulation.

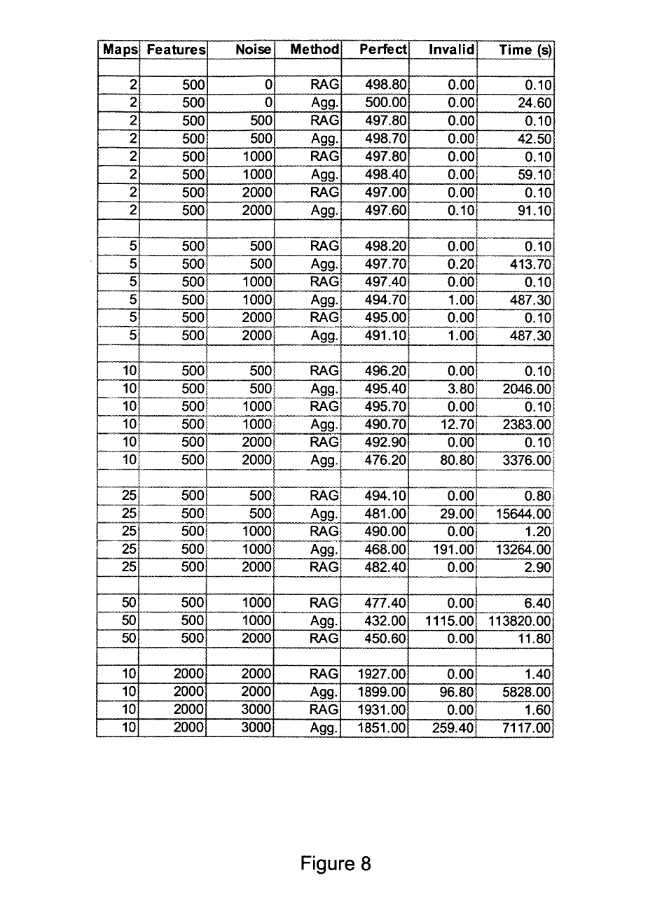

FIG. 8 summarizes the results. A group of features is called “perfect” if it contains all input observations of exactly one reference feature from the reference map. It is called “invalid” if it exceeds the maximum mass/charge or retention time matching distance between two features for some pair of features in the group. Generally, this does not occur with RAG, but can happen with pair-wise methods such as Aggregator because of the drift associated with using the mean values for a group of features when merging maps. The running time is presented in seconds. RAG was run on a dual Pentium Xeon machine running Linux; the Aggregator was run on a quad-Alpha Compaq computer running Digital UNIX.

The table shows that RAG and the Aggregator perform similarly in the ideal case where there is no noise, or where only two maps are being compared. However, as the amount of noise and number of maps grow, RAG is more accurate and the computational time is much lower. Extremely large test cases were not run with Aggregator due to its resource requirements.

### Example 2

### Clinical Data

RAG was tested on a set of 107 purified human serum albumin (HSA) samples. These samples were digested with bovine trypsin and sent through the LC/MS process. This resulted in 107 maps possessing between 504 and 715 features. To evaluate the results, several computational tryptic digestions of HSA and bovine trypsin—which remains in the sample after digestion—were performed. Only peptides likely to fall within the detectable mass/charge ratio range of the instrument were considered. If both ends of the peptides are constrained to be tryptic and no mis-cleavages occur, the result is 81 peptides. The number grows to 166 peptides with 1 mis-cleavage and 225 with 2. Of course, many variables affect how many features are detected; for example, a peptide may ionize to multiple charge states or, conversely, may fail to ionize at all. Nevertheless, the number of features called per map far exceeds the number expected; most of these extra features are much more likely to be noise than signal.

RAG detected 55 fully-populated groups across the samples, and 176 groups present in 80% of the groups. These numbers agree well with the theoretical digestions. In addition, a hand-curated set of 15 reliable, well-isolated reference features was developed in order to judge the quality of each individual map. RAG was able to successfully generate a clique for each reference feature and populate it with the correct representative from each map.

One skilled in the art will appreciate that the teachings herein are applicable to almost any protocol which produces sets of 1D or 2D points with error as output. Other potential applications include 1D and 2D gels, and single mass spectra, and the finding of biomarkers in serum which involves comparing single spectra from a large number of samples. (E. Petricoin, A. Ardekani, B. Hitt, P. Levine, V. Fusaro, S. Steinberg, G. Mills, C. Simone, D. Fishman, E. Kohn, and L. Liotta. Use of proteomic patterns in serum to identify ovarian cancer. Lancet, 359:572-577, 2002.)

### Example 3

### Peptide Identification and Quantification

Some embodiments of the teachings analyze samples in order to identify unknown peptides. In such cases, a reference sample containing known peptides is first analyzed producing a 2-dimensional feature map containing m/z and retention time information. Then, a plurality of samples, which can contain unknown peptides, are analyzed producing a plurality of 2-dimensional feature maps. Using embodiments of the teachings disclosed herein, the maps are aligned via global optimization. Unknown peptides that align with the known peptides contained in the reference map can be identified. One skilled in the art will appreciate that in addition to identification of the peptides, this technique can also be used to perform relative quantification by computing a ratio of the unknown to known peptides. One will also appreciate that absolute quantification can be reported if one of the amounts in the ratio is known.

1. A method for matching features between a plurality of two-dimensional feature maps comprising,
receiving feature location information for features located in each of said plurality of feature maps,
receiving feature location error estimates of said feature locations,
performing a global optimization based on said feature location information and said feature location error estimates to match individual features related to the same feature across the maps, and
outputting the results.

2. The method of claim 1 where the two-dimensional feature maps contain chromatographic and mass spectrometry data.

3. The method of claim 1 where the two-dimensional feature maps contain data from two-dimensional electrophoresis gels.

4. The method of claim 1 wherein the global optimization technique comprises,
defining rectangles based on the location of the features and the estimates of location error,
determining maximal cliques,
identifying ambiguous rectangles, and
assigning each ambiguous rectangles to a single clique.

5. The method of claim 4 wherein assigning ambiguous rectangles to cliques comprises,
determining a score based on the average overlap of each ambiguous rectangle with the members of each clique to which it belongs, and
assigning each ambiguous rectangle to the clique that resulted in the highest score.

6. A method of peptide analysis comprising,
analyzing a reference sample containing peptides of known composition on a liquid chromatography/mass spectrometry instrument,
analyzing a plurality of samples containing peptides of unknown composition on a liquid chromatography/mass spectrometry instrument,
receiving mass to charge ratio and retention time information for both the reference sample and plurality of samples,
estimating the error in the mass to change ratio and retention time information,
determining the identity of the unknown peptides by performing a global optimization technique and aligning the unknown peptides with the peptides in the reference sample, and
reporting the results.

7. The method of claim 6 comprising,
performing relative quantitation between the peptides in the reference sample and the identified peptides in each of the samples of unknown composition.

8. A system for matching features between a plurality of two-dimensional feature maps comprising,
a processor configured to execute program instructions, and
a memory containing program instructions for execution by the processor to;
receive feature location information for features located in each of said plurality of feature maps,
receive feature location error estimates of said feature locations,
perform a global optimization based on said feature location information and said feature location error estimates to match individual features related to the same feature across the maps, and
output the results.

9. The system of claim 8 where the two-dimensional feature maps contain chromatographic and mass spectrometry data.

10. The method of claim 8 where the two-dimensional feature maps contain data from two-dimensional electrophoresis gels.

11. A computer readable medium containing instructions for controlling a computer system to perform a method for matching features between a plurality of two-dimensional feature maps comprising,
receiving feature location information for features located in each of said plurality of feature maps,
receiving feature location error estimates of said feature locations,
performing a global optimization based on said feature location information and said feature location error estimates to match individual features related to the same feature across the maps, and
outputting the results.

12. The method of claim 11 where the two-dimensional feature maps contain chromatographic and mass spectrometry data.

13. The method of claim 11 where the two-dimensional feature maps contain data from two-dimensional electrophoresis gels.
